(19) United States
(12) Patent Application Publication
(10) Pub. No.: US 2023/0039740 A1
(43) Pub. Date: Feb. 9, 2023

(54) ANOMALY DETECTION APPARATUS, ANOMALY DETECTION METHOD AND PROGRAM

(71) Applicant: Nippon Telegraph and Telephone Corporation, Tokyo (JP)

(72) Inventors: Zhao WANG, Musashino-shi, Tokyo (JP); Yusuke NAKANO, Musashino-shi, Tokyo (JP); Keishiro WATANABE, Musashino-shi, Tokyo (JP); Kengo TAJIRI, Musashino-shi, Tokyo (JP)

(21) Appl. No.: 17/778,696

(22) PCT Filed: Nov. 21, 2019
(86) PCT No.: PCT/JP2019/045661

§ 371 Date: May 20, 2022

(51) Int. Cl. G06N 3/08

(52) U.S. Cl. CPC G06N 3/08

(57) ABSTRACT

An anomaly detection apparatus includes an anomaly detection unit configured to perform anomaly detection on time series data. The anomaly detection unit includes an encoding unit configured to encode the time series data by using a plurality of LSTM cells, an attention layer configured to calculate a weight of attention on an output from the encoding unit, a context generation unit configured to generate a context vector by applying the weight to the output from the encoding unit, and a decoding unit configured to reconfigure the time series data by using the plurality of LSTM cells in accordance with the context vector, and thereby, enables improvement in accuracy for the anomaly detection and efficient learning.

### TECHNICAL FIELD

The present invention relates to an anomaly detection apparatus, an anomaly detection method, and a program.

### BACKGROUND ART

There is a growing need in various networking domains for functions to process, analyze, and evaluate network data (such as sys-log, FLOW, and mib) and automatically detect and identify anomalous patterns in the data. In recent years, a rapid increase in network anomaly detection studies by deep neural networks has been observed, and higher accuracy and more robust results than those by known rule-based detection methods have been obtained (NPLs 1 and 2).

There are primarily two types of network anomaly detection, which are supervised and unsupervised anomaly detections. In the supervised anomaly detection, labels of both normal data instances and anomalous data instances are used to train supervised binary or multi-class classifier. While supervised learning methods have improved in performance, these methods have less labeled training data in actual use scenes (NPL 1).

The unsupervised deep anomaly detection technology is a technique for reconfiguring data without labeling, and an autoencoder as a representative technique thereof (NPL 1) is a neural network that learns to copy an input to an output.

Furthermore, long short-term memory (LSTM) networks used to detect time series outliers (NPL 2) have abilities to maintain a long-term memory, and thus, stacking recurrent hidden layers also enables the learning of higher level temporal change features, for faster learning of time series changes with sparser representations. The LSTM-based autoencoder for time series anomaly detection is also a type of the unsupervised anomaly detection. An encoder learns a vectorial representation of the input time series, and a decoder reconstructs the time series by using an encoder forward transmission context representation.

### CITATION LIST

### Non Patent Literature

NPL 1: Sakurada, Mayu, and Takehisa Yairi, “Anomaly detection using autoencoders with nonlinear dimensionality reduction.” Proceedings of the MLSDA 2014 2nd Workshop on Machine Learning for Sensory Data Analysis. ACM, 2014.

NPL 2: Malhotra, Pankaj, et al., “Long short term memory networks for anomaly detection in time series.” Proceedings. Presses universitaires de Louvain, 2015.

### SUMMARY OF THE INVENTION

### Technical Problem

However, due to mobile networks, social media, etc. in the IoT era, network data has explosively increased. Once the data becomes large due to the increased number of connected devices, it is not possible to label all data. Also, as for dynamic concept drift (a temporal change in a concept to be learned from data, e.g., continued change in a feature amount value due to system updates), collecting vast data during a certain period of time for always performing batch learning or re-learning (off-line learning) in the related art is very inefficient in large scale ICT systems.

In the anomaly detection algorithms in the related art, a static training data set is assumed to be prepared before performing actual detection, and is used to extract all necessary information. In other words, it is necessary to learn at a time by using the data set, and hence to prepare a data set containing sufficient information. This approach is not suitable for situations where a complete training data set is not previously available.

That is, while various algorithms have been proposed based on learning patterns only at normal time as application to anomaly detection of a network environment of the related art, none of algorithms is designed for online learning of high accuracy time-series analysis and large scale data based on unsupervised training algorithms.

The present invention has been made in view of the above and has an object to enable improvement in accuracy for the anomaly detection and efficient learning.

### Means for Solving the Problem

In order to solve the above-described problem, an anomaly detection apparatus includes an anomaly detection unit configured to perform anomaly detection on time series data, wherein the anomaly detection unit includes an encoding unit configured to encode the time series data by using a plurality of LSTM cells, an attention layer configured to calculate a weight of attention on an output from the encoding unit, a context generation unit configured to generate a context vector by applying the weight to the output from the encoding unit, and a decoding unit configured to reconfigure the time series data by using the plurality of LSTM cells in accordance with the context vector.

### Effects of the Invention

It is possible to enable improvement in accuracy for anomaly detection and efficient learning.

### BRIEF DESCRIPTION OF DRAWINGS

FIG. 1 is a diagram illustrating an exemplary hardware configuration of an anomaly detection apparatus 10 according to an embodiment of the present invention.

FIG. 2 is a diagram illustrating an exemplary functional configuration of the anomaly detection apparatus 10 according to the embodiment of the present invention.

FIG. 3 is a diagram illustrating an exemplary configuration of an anomaly detection unit 12.

FIG. 4 is a diagram illustrating an exemplary configuration of an LSTM cell included in an encoding unit 121 and a decoding unit 122.

FIG. 5 is a flowchart illustrating an example of a processing procedure of online learning in the anomaly detection unit 12.

### DESCRIPTION OF EMBODIMENTS

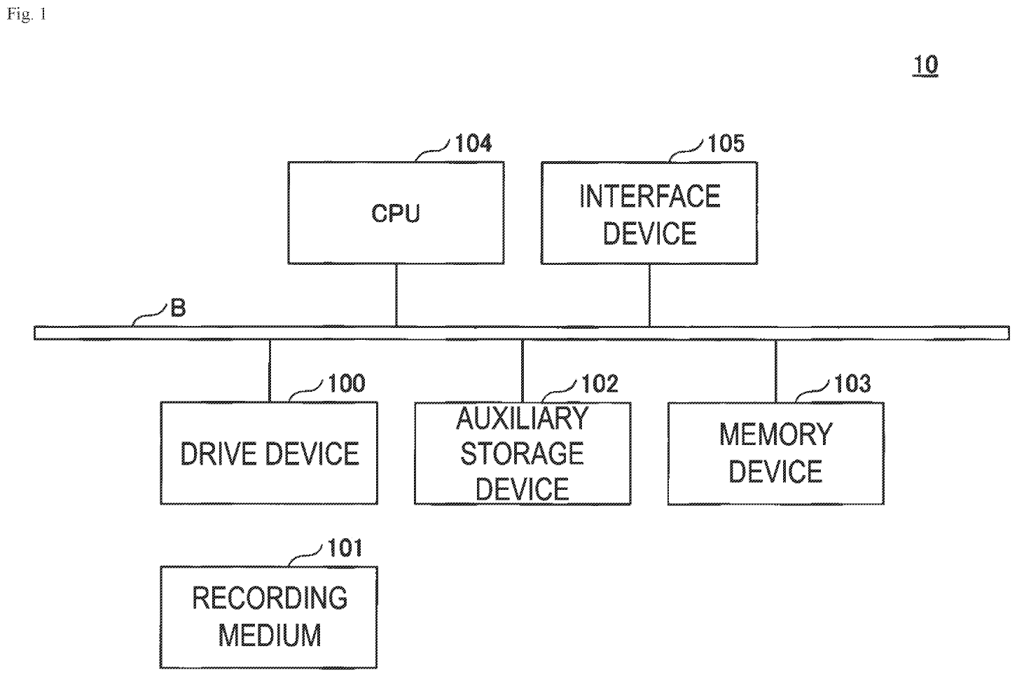

Hereinafter, an embodiment of the present disclosure will be described with reference to the drawings. FIG. 1 is a diagram illustrating an exemplary hardware configuration of an anomaly detection apparatus 10 according to an embodiment of the present invention. The anomaly detection apparatus 10 in FIG. 1 includes a drive device 100, an auxiliary storage device 102, a memory device 103, a CPU 104, an interface device 105, and the like which are connected to each other via a bus B.

A program that realizes processing in the anomaly detection apparatus 10 is provided via a recording medium 101 such as a CD-ROM. When the recording medium 101 having the program stored therein is set in the drive device 100, the program is installed in the auxiliary storage device 102 from the recording medium 101 via the drive device 100. However, the program does not necessarily have to be installed from the recording medium 101, and may be downloaded from another computer via a network. The auxiliary storage device 102 stores the installed program and also stores necessary files, data, and the like.

The memory device 103 reads and stores the program from the auxiliary storage device 102 when the program is instructed to start. The CPU 104 executes the function for the anomaly detection apparatus 10 according to the program stored in the memory device 103. The interface device 105 is used as an interface for connection to a network.

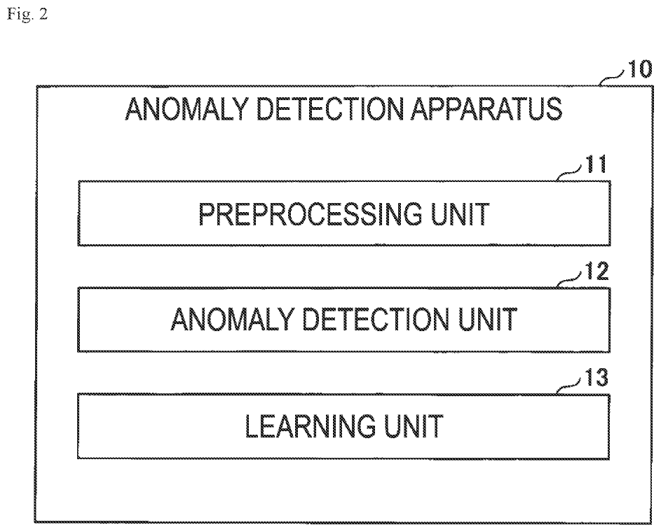

FIG. 2 is a diagram illustrating an exemplary functional configuration of the anomaly detection apparatus 10 according to the embodiment of the present invention. In FIG. 2, the anomaly detection apparatus 10 includes a preprocessing unit 11, an anomaly detection unit 12, a learning unit 13, and the like. Each of these units is realized by processing that one or more programs installed in the anomaly detection apparatus 10 cause the CPU 104 to execute.

The preprocessing unit 11 performs preprocessing on stream data (time series data) such as network data (sys-log, FLOW, mib, or the like) that is a target of anomaly detection. The anomaly detection unit 12 is a neural network that detects anomalies in accordance with the preprocessed time series data. The learning unit 13 controls learning processing of a learning parameter group of the neural network as the anomaly detection unit 12.

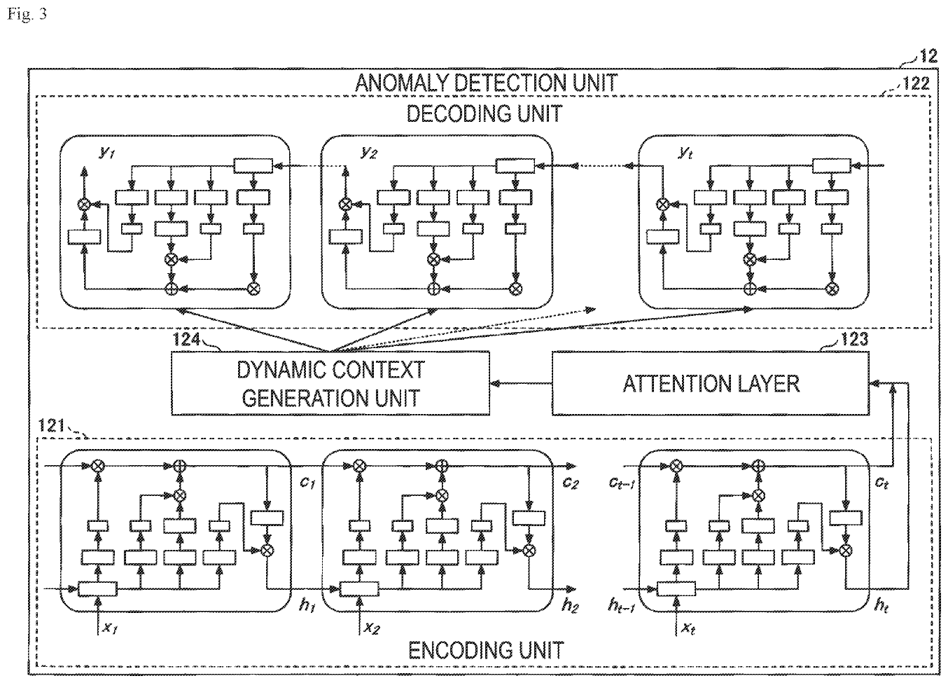

FIG. 3 is a diagram illustrating an exemplary configuration of the anomaly detection unit 12. As illustrated in FIG. 3, the anomaly detection unit 12 includes an encoding unit 121 as an encoder and a decoding unit 122 as a decoder, and additionally, an attention layer 123 and a dynamic context generation unit 124. Each of the encoding unit 121 and the decoding unit 122 includes a plurality of long short-term memory (LSTM) cells. That is, the anomaly detection unit 12 is configured as an LSTM autoencoder with attention.

Such an anomaly detection unit 12 is a model capable of unsupervised learning of time series data, and unlike a known autoencoder, is a model having a dependency on time series data. Furthermore, because the anomaly detection unit 12 is with attention (or includes the attention layer 123), it is possible to improve the accuracy of the anomaly detection by generating dynamic hidden information for each decoding step.

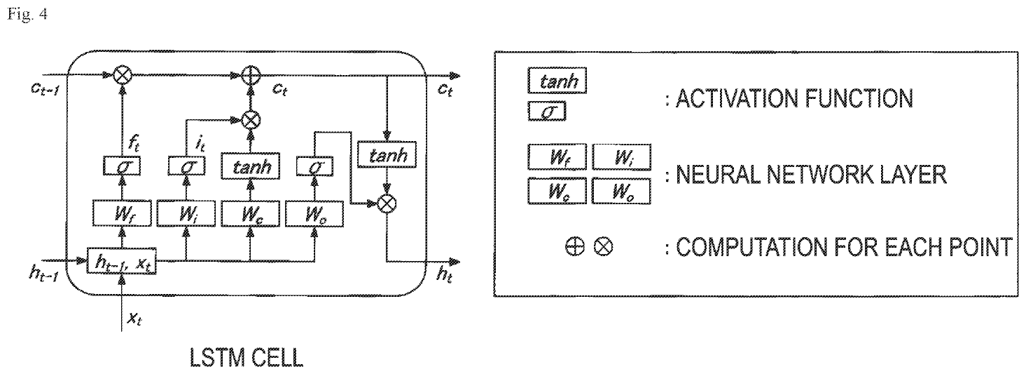

FIG. 4 is a diagram illustrating an exemplary configuration of the LSTM cell included in the encoding unit 121 and the decoding unit 122. The LSTM cell illustrated in FIG. 4 is effective against gradient explosion and vanishing problem that may be encountered in training a known RNN by leveraging activation vectors of a forget gate, an input gate, and an output gate, allowing long-term dependencies to be learned (‘Malhotra, Pankaj, Lovekesh Vig, Gautam Shroff, and Puneet Agarwal. “Long short term memory networks for anomaly detection in time series.” In Proceedings Presses universitaires de Louvain, pp. 89-95, (2015).’ hereinafter, referred to as “cited document 1”).

A compact form of forward equations for the LSTM cell is as follows.

[Math. 1]

fₜ=σ(W_{f}[h_{t'11},xₜ]+b_{f}) (1)

iₜ=σ(Wᵢ[hₜ₋₁,xₜ]+bᵢ) (2)

cₜ=fₜ*cₜ₋₁+iₜ*tanh(W_{c}[hₜ₋₁, xₜ]+b_{c}) (3)

oₜ=σ(Wₒ[hₜ₋₁, xₜ]+b₀) (4)

hₜ=oₜ*tanh(cₜ) (5)

Here, fₜ, iₜ, oₜ represent respective outputs of the forget gate, the input gate, and the output gate, and ct and ht represent respective outputs of the LSTM cell. The details related to the LSTM such as a backward learning method are described in reference document 1, for example.

Equations (1) to (5) can be combined as follows.

[Math. 2]

hₜ, cₜ=LSTM(hₜ₋₁,cₜ₋₁,xₜ) (6)

LSTM Autoencoder Model with Attention

The input to the anomaly detection unit 12 (LSTM autoencoder with attention) illustrated in FIG. 3 is time series data Xₐₗₗ={x₁, x₂, . . . , x₁, . . . , x_{L}}, where L is a temporal length, and each x₁ is a m-dimensional vector. Although such a plurality of pieces of time series data are available, in the present embodiment, consider a scenario in which time series data Xₐₗₗ can be acquired by defining a window having a length T over a larger time series. One window is expressed as X={x₁, x₂ . . . x_{T}}, where X∈R^{m×T}.

As illustrated in FIG. 3, the encoding unit 121 (encoder) encodes the time series data using the neural network connecting T LSTM cells. Specifically, the encoding unit 121 maps the input window to a fixed-dimensional vectorial representation. Each of the LSTM cells in the encoding unit 121 performs the following calculations.

[Math. 3]

h_{T}, c_{T}=LSTM(h_{T-1}, c_{T-1}, xₜ)=LSTM(LSTM(h_{T-2}, c_{T-2}, xₜ₋₁), xₜ)=LSTM(LSTM( . . . LSTM(h₀, c₀, xₜ) . . . , xₜ₋₂),xₜ₋₁), xₜ) (7)

Here, h_{T} and c_{T} represent context vectors generated by LSTM-coding the window data having the size T, T consecutive times.

The decoding unit 122 (decoder) uses the context vectorial representation to generate data Y={y₁, y₂ . . . y_{T}}, Y∈R^{m×T}, which reconfigures the input window X={x₁, x₂ . . . x_{T}}, where X∈R^{m×T}. The decoding unit 122, similarly to the encoding unit 121, uses the network connecting T LSTM cells in each decoding step to generate each piece of reconfigured data yₜ∈Y in the reverse order Y′={y_{T}, y_{T-1} . . . y₁}, An initial state (h₀^{de}, c₀^{de}) of the decoding unit 122 is an output (h_{T}, c_{T}) of the encoding unit 121.

[Math. 4]

yₜ=LSTM(hₜ^{de}, cₜ^{de}, yₜ₊₁)t∈(T,T−1 . . . 1) (8)

Here, in order to achieve a high accurate and high interpretable time series decoder, the decoding unit 122 uses a dynamic context vector that is calculated by the dynamic context generation unit 124 in accordance with Equation (8) below, unlike reference document 1 in which fixed cₜ^{de} used in each decoding step is expressed as cₜ^{de}≡c_{T}.

$$\begin{matrix}[ Math . 5 ] & \\ {c}_{t}^{de} = {\sum }_{i = 1}^{T} {a}_{ti} {h}_{i} t ∈ ( T , T - 1 … 1 ) & ( 9 )\end{matrix}$$

Here, t∈(T, T−1, . . . , 1) represents each decoding step by the decoding unit 122, and hᵢ means a hidden vector in each decoding step. In other words, in each decoding step t∈(T, T−1 . . . 1) of the decoding unit 122, the context vector cₜ^{de} indicates a weighted sum of output vectors h₁, h₂, h₃ . . . , h_{T} of the encoding unit 121, and the vectors h₁, h₂, h₃ . . . , h_{T} are scaled by a degree of relevance based on an attention weight aₜᵢ to the input vector X={x₁, x₂ . . . x_{T}}.

The attention layer 123 calculates the attention weight ati in accordance with Equations (10) and (11) below.

$$\begin{matrix}[ Math . 6 ] & \\ {a}_{ti} = \frac{{β}_{ti}}{{Σ}_{{i}^{′}}^{T} {β}_{{ti}^{′}}} & ( 10 )\end{matrix}$$

$${β}_{t i} = tanh ( {W}_{a} * [ {h}_{i} , {c}_{i - 1} ] + b ) \qquad ( 11 )$$

Here, Wₐ and b represent learnable attention weights, and concatenation of [hᵢ, cᵢ₋₁] means that the attention weight is generated with not only the input information of the decoding unit 122 but also the past hidden state information being into consideration. Unlike the known fixed context information, the generation of the dynamic hidden information at each step of the decoding unit 122 can improve the accuracy of the anomaly detection.

Online Learning

In recent years, online learning algorithms have been of great interest in developing intelligent agents that can perform online learning in complex IoT environments (‘Zhou, Guanyu, Kihyuk Sohn, and Honglak Lee. “Online incremental feature learning with denoising autoencoders.” In Artificial intelligence and statistics, pp. 1453-1461, (2012).’).

The online learning is a technique that processes in real-time and continually learns data, and is also called process incremental learning. Such learning methods can initiate anomaly detection as soon as possible with very little initial knowledge and apply this knowledge when new data becomes available. This learning technique is capable of processing time series data. An online learning model, unlike known batch learning, is trained stepwise with available new information, and the model weights are updated at all times and also believed to be effective for prediction of stream data or anomaly detection.

However, most related studies emphasize that test-then-train is performed each time data is provided, but do not refer to a scenario, likely to occur in the IoT network, that there is no labeling when the data streams come in order in real application. Therefore, calculation such as a loss function or updating of training parameters has also been made impossible (‘Mohammadi, Mehdi, Ala Al-Fuqaha, Sameh Sorour, and Mohsen Guizani. “Deep learning for IoT big data and streaming analytics: A survey.” IEEE Communications Surveys & Tutorials 20, no. 4: 2923-2960. (2018)’).

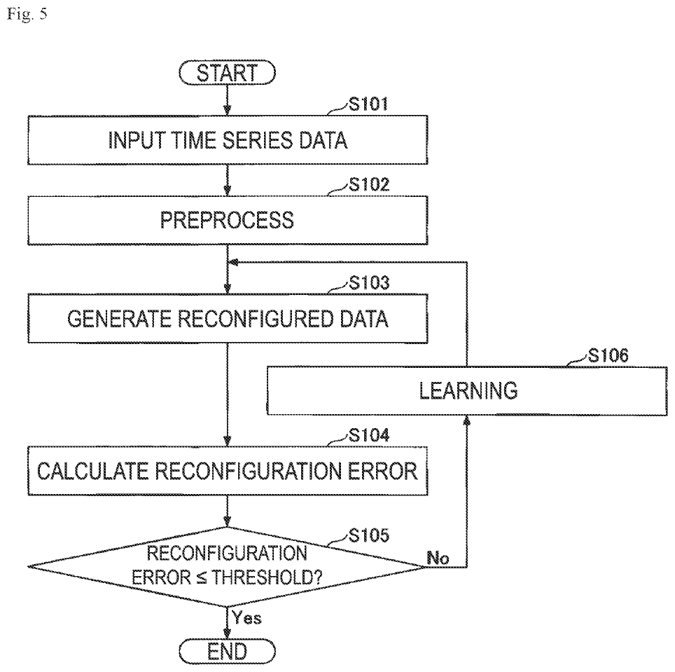

Subsequently, the learning processing in the anomaly detection unit 12 will be described. FIG. 5 is a flowchart illustrating an example of a processing procedure of online learning in the anomaly detection unit 12.

In step S101, the preprocessing unit 11 performs preprocessing (AGGREGATION, normalization, etc.) on potentially infinite time series data Xₐₗₗ={x₁, x₂, . . . , x₁ . . . }. Here, the preprocessing such as AGGREGATION or normalization depends on the type of data, and thus details thereof will be omitted. The preprocessing unit 11 also writes the preprocessed data into the continuous windows. For example, the window size is T and the preprocessed data is written into a window X¹={x₁, x₂ . . . , x_{T}}, a window X²={x_{T+1}, x_{T+2} . . . , x_{2T}}, . . . Note that a size N of a trunk is n, and one data trunk includes n continuous windows. Here, in a case that the size N of the trunk is 1, WINDOW-BY WINDOW learning is performed, and in a case of N>1, CHRUNK-BY-CHRUNK learning is performed. The larger the trunk size is, the faster the learning converges, but the longer a test interval becomes.

Next, the anomaly detection unit 12 inputs each piece of preprocessed data Xⁿ∈{X¹, X², . . . , X^{N}} in one trunk into Equation (8) to generate each piece of reconfigured data Yⁿ∈{Y¹, Y², . . . , Y^{N}} (S103).

Subsequently, the learning unit 13 calculates a reconfiguration error in accordance with the following loss function (S104).

$$\begin{matrix}[ Math . 7 ] & \\ Loss = \frac{1}{N} {\sum }_{i = 1}^{N} {( {X}^{n} - {Y}^{n} )}^{2} = \frac{1}{N} \cdot \frac{1}{T} {\sum }_{i = 1}^{N} {\sum }_{t = 1}^{T} {( {x}^{t , n} - {y}^{t , n} )}^{2} & ( 12 )\end{matrix}$$

Here, N represents the trunk size and T represents the window size.

Subsequently, the learning unit 13 compares the reconfiguration error with a threshold (S105). In a case that the reconfiguration error is larger than the threshold (No in S105), the learning unit 13 performs learning (S106) by the anomaly detection unit 12 (the LSTM autoencoder model) by using an Adam optimization method. The Adam optimization method demonstrates experimentally best performance by updating the weight on each parameter with an appropriate learning rate by taking into account a mean square and a mean of gradients as a primary moment and a secondary moment. For the online learning of the LSTM autoencoder, it is believed that the Adam method converges the earliest and stabilizes (the accuracy does not fall down even if the learning rate is set widely).

A main difference between the online learning and the known offline (off-line) learning is that the online learning does not strictly isolate training and test data, but instead each instance (the trunk in this case) is first used for model testing, and then used for training. However, to improve online learning accuracy, the offline learning may be used with small batch data when initializing the model (‘Zhou, Guanyu, Kihyuk Sohn, and Honglak Lee. “Online incremental feature learning with denoising autoencoders.” In Artificial intelligence and statistics, pp. 1453-1461, (2012).’).

After step S106, step S103 and subsequent steps are repeated. When the reconfiguration error is less than or equal to the threshold, the processing procedure in FIG. 5 ends.

Note that when the anomaly detection task is performed, steps S101 to S105 in FIG. 5 are performed to detect abnormalities as long as the reconfiguration error is larger than the threshold.

As described above, according to the present embodiment, it is possible to enable the improvement in accuracy for the anomaly detection and the efficient learning. Specifically, effects (1) and (2) below can be achieved by constructing the LSTM autoencoder.
(1) The anomaly detection can be performed by a machine learning method without labeling. In other words, by learning only the given normal data, the present embodiment is effective for both known abnormal pattern and unknown anomaly pattern, and the anomaly detection can be performed also on higher order data by a robust technique than that of the rule-based anomaly detection.
(2) The anomaly detection can be performed in the unsupervised learning combined with an autoencoder by utilizing the advantage that a long-term change pattern in the time series of the LSTM network can be detected. In time series data, a case that a value is normal but a behavior is anomalous (for example, periodicity is disintegrated) cannot be detected by the known unsupervised learning method. On the other hand, the present embodiment can be specialized in that the given normal time series data is transferred in the time direction in the hidden layer of the LSTM cell, and information before and after the time series data is handled successfully. The unsupervised learning can also be performed through a reconstruction structure of the autoencoder.

In addition, the anomaly detection unit 12 of the present embodiment including the attention layer 123 (attention mechanism) allows the following effect (3) to be obtained.
(3) The accuracy of the anomaly detection can be improved by generating the dynamic context vector in each decoding step. In the known LSTM autoencoder model, input sequence information can only be conveyed as a vector compressed by the encoder to the decoder, so in a case that the input sequence is long, the input sequence information is difficult to securely convey to the decoder. In the present embodiment, it is possible to improve the accuracy of the anomaly detection by leveraging the attention mechanism to learn also the dynamic context vector indicating the feature amounts of which time points of the input and output are associated.

Furthermore, by performing the online learning for the anomaly detection unit 12, the following effect (4) can be obtained.
(4) The learning can be continually performed without storing all training data. In large scale IoT systems, unlike the known methods in which the all data is stored and learned, it is very efficient to deal with the learning and detecting online without storing the time series data, and the need for re-learning even against Concept drift can be eliminated (because the test of whether it is anomalous ends the determination until the next data trunk arrives, the learning phase continually performs the unsupervised learning, and does not need to store or label the data).

Although the embodiments of the present disclosure have been described in detail above, the present disclosure is not limited to such specific embodiments, and various modifications and changes can be made without departing from the gist of the present disclosure described in the aspects.

### REFERENCE SIGNS LIST

10 Anomaly detection apparatus
11 Preprocessing unit
12 Anomaly detection unit
13 Learning unit
100 Drive device
101 Recording medium
102 Auxiliary storage device
103 Memory device
104 CPU
105 Interface device
121 Encoding unit
122 Decoding unit
123 Attention layer
124 Dynamic context generation unit
B Bus

1. An anomaly detection apparatus comprising:
an anomaly detection unit, implemented using one or more computing devices, configured to perform anomaly detection on time series data,
wherein the anomaly detection unit includes:
an encoding unit, implemented using one or more computing devices, configured to encode the time series data by using a plurality of long short-term memory (LSTM) cells,
an attention layer, implemented using one or more computing devices, configured to calculate a weight of attention on an output from the encoding unit,
a context generation unit, implemented using one or more computing devices, configured to generate a context vector by applying the weight to the output from the encoding unit, and
a decoding unit, implemented using one or more computing devices, configured to reconfigure the time series data by using the plurality of LSTM cells based on the context vector.

2. The anomaly detection apparatus according to claim 1, further comprising:
a learning unit, implemented using one or more computing devices, configured to perform online learning for the anomaly detection unit.

3. An anomaly detection method performed by an anomaly detection apparatus for performing anomaly detection on time series data, the anomaly detection method comprising:
an encoding procedure of encoding the time series data by using a plurality of long short-term memory (LSTM) cells;
a calculating procedure of calculating a weight of attention on an output from the encoding procedure;
a context generation procedure of generating a context vector by applying the weight to the output from the encoding procedure; and
a decoding procedure of reconfiguring the time series data by using the plurality of LSTM cells based on the context vector.

4. The anomaly detection method according to claim 3, further comprising:
a learning procedure of performing online learning for the anomaly detection apparatus.

5. A non-transitory recording medium storing a program, wherein execution of the program causes one or more computers of an anomaly detection apparatus to erform operations comprising:
an encoding procedure of encoding the time series data by using a plurality of long short-term memory (LSTM) cells;
a calculating procedure of calculating a weight of attention on an output from the encoding procedure;
a context generation procedure of generating a context vector by applying the weight to the output from the encoding procedure; and
a decoding procedure of reconfiguring the time series data by using the plurality of LSTM cells based on the context vector.

6. The recording medium according to claim 5, wherein the operations further comprise a learning procedure of performing online learning for the anomaly detection apparatus.
